(19) United States
(12) Patent Application Publication
(10) Pub. No.: US 2024/0281663 A1
(43) Pub. Date: Aug. 22, 2024

(54) PROMPT GENERATION FOR LARGE LANGUAGE MODEL USING TEXTUAL CONTENT

(71) Applicant: Samsung Electronics Co., Ltd., Suwon-si (KR)

(72) Inventors: Winston Chen, Winchester, MA (US); Laszlo Gombos, Winchester, MA (US)

(21) Appl. No.: 18/427,400

(22) Filed: Jan. 30, 2024

Related U.S. Application Data
(60) Provisional application No. 63/446,740, filed on Feb. 17, 2023.

(51) Int. Cl. G06N 3/0895

(52) U.S. Cl. CPC G06N 3/0895

(57) ABSTRACT

A method includes obtaining, using at least one processing device of an electronic device, information associated with a webpage presented to a user. The method also includes providing, using the at least one processing device, the information to an on-device machine learning model of the electronic device. The method further includes generating, using the on-device machine learning model, a prompt for a large language model based on the information. The prompt includes an action from a set of candidate actions that the large language model is able to perform and at least some of the information. The method also includes providing, using the at least one processing device, the prompt as input to the large language model and receiving, using the at least one processing device, a response from the large language model. In addition, the method includes presenting, using the at least one processing device, the response to the user.

### CROSS-REFERENCE TO RELATED APPLICATION AND PRIORITY CLAIM

This application claims priority under 35 U.S.C. § 119(e) to U.S. Provisional Patent Application No. 63/446,740 filed on Feb. 17, 2023, which is hereby incorporated by reference in its entirety.

### TECHNICAL FIELD

This disclosure relates generally to machine learning systems and processes. More specifically, this disclosure relates to prompt generation for a large language model using textual content.

### BACKGROUND

Large language models are increasing in popularity due to their ability to understand natural language inputs and generate understandable responses to those inputs. For example, a large language model can receive a user query as an input, where the user query asks the large language model to provide an answer to a question or otherwise provide information satisfying the user query. Because of their capabilities, large language models are opening the door for a number of possible applications involving various human-machine interactions.

### SUMMARY

This disclosure relates to prompt generation for a large language model using textual content.

In a first embodiment, a method includes obtaining, using at least one processing device of an electronic device, information associated with a webpage presented to a user. The method also includes providing, using the at least one processing device, the information to an on-device machine learning model of the electronic device. The method further includes generating, using the on-device machine learning model, a prompt for a large language model based on the information. The prompt includes (i) an action from a set of candidate actions that the large language model is able to perform and (ii) at least some of the information. The method also includes providing, using the at least one processing device, the prompt as input to the large language model. The method further includes receiving, using the at least one processing device, a response from the large language model. In addition, the method includes presenting, using the at least one processing device, the response to the user.

In a second embodiment, an electronic device includes at least one processing device configured to obtain information associated with a webpage presented to a user. The at least one processing device is also configured to provide the information to an on-device machine learning model of the electronic device. The at least one processing device is further configured to generate, using the on-device machine learning model, a prompt for a large language model based on the information. The prompt includes (i) an action from a set of candidate actions that the large language model is able to perform and (ii) at least some of the information. In addition, the at least one processing device is configured to provide the prompt as input to the large language model, receive a response from the large language model, and present the response to the user.

In a third embodiment, a non-transitory machine readable medium contains instructions that when executed cause at least one processor of an electronic device to obtain information associated with a webpage presented to a user. The non-transitory machine readable medium also contains instructions that when executed cause the at least one processor to provide the information to an on-device machine learning model of the electronic device. The non-transitory machine readable medium further contains instructions that when executed cause the at least one processor to generate, using the on-device machine learning model, a prompt for a large language model based on the information. The prompt includes (i) an action from a set of candidate actions that the large language model is able to perform and (ii) at least some of the information. In addition, the non-transitory machine readable medium contains instructions that when executed cause the at least one processor to provide the prompt as input to the large language model, receive a response from the large language model, and present the response to the user.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example network configuration including an electronic device in accordance with this disclosure;

FIG. 2 illustrates an example architecture for prompt generation for a large language model using textual content in accordance with this disclosure;

FIGS. 3 through 6 illustrate example uses of prompt generation for a large language model using textual content in accordance with this disclosure;

FIG. 7 illustrates an example method for prompt generation for a large language model using textual content in accordance with this disclosure; and

FIGS. 8 through 10 illustrate example methods that may supplement prompt generation for a large language model using textual content in accordance with this disclosure.

### DETAILED DESCRIPTION

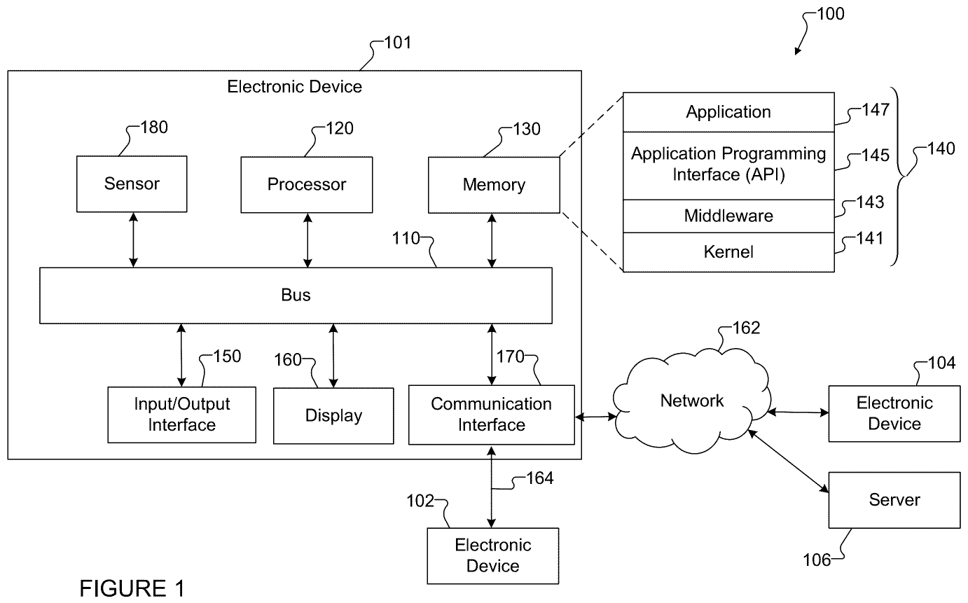

FIGS. 1 through 10, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, large language models are increasing in popularity due to their ability to understand natural language inputs and generate understandable responses to those inputs. For example, a large language model can receive a user query as an input, where the user query asks the large language model to provide an answer to a question or otherwise provide information satisfying the user query. Because of their capabilities, large language models are opening the door for a number of possible applications involving various human-machine interactions.

A large language model can generally take user input and generate some type of output in response. However, one issue with large language models is that their outputs tend to be highly dependent on the specific wordings of their inputs. In other words, the wording of a user input can greatly impact the content of a large language model's response, even if different wordings request the exact same information from the large language model. Depending on the user's goal, the user might need to repeatedly modify the phrasing of his or her user input in order to obtain desired results from a large language model.

This disclosure provides various techniques for prompt generation for a large language model using textual content. As described in more detail below, information associated with a webpage presented to a user can be obtained by an electronic device. In some cases, the information associated with the webpage may include text or other content included in the webpage, a uniform resource locator (URL) of the webpage, or webpage metadata associated with the webpage. Also, in some cases, additional information may be obtained, such as a browsing history associated with the user and profile information associated with the user. The information is provided to an on-device machine learning model of the electronic device. The on-device machine learning model refers to a machine learning model that executes on the electronic device itself (rather than on a remote server or other external device). Using the on-device machine learning model, a prompt for a large language model is generated based on the information, where the prompt includes (i) an action from a set of candidate actions that the large language model is able to perform and (ii) at least some of the information. The set of candidate actions may include various actions associated with the webpage that can be performed by the large language model, such as locating content related to the webpage, generating a summary of the webpage, identifying one or more key points of the webpage, or answering a user question about the content of the webpage. The prompt is provided as input to the large language model, and a response is received from the large language model and presented to the user.

Various other operations may be supported as part of these techniques. As an example, how the user interacts with the presented response may be identified, and one or more weights of the on-device machine learning model may be updated based on how the user interacts with the presented response. For instance, the one or more weights may be updated based on whether the user copies content included in the response, a time that the user spends viewing the response, or how the user rates the response. As another example, a likelihood that the large language model was trained using outdated training data may be determined, and the content of the prompt can vary based on the determination. As yet another example, a determination can be made whether the webpage includes sensitive information, and one or more steps can be taken to prevent the sensitive information from being transmitted off device (such as by not providing the sensitive information to the on-device machine learning model or not including the sensitive information in the prompt). As still another example, multiple prompts with different phrasings can be generated and provided to the large language model, and multiple responses can be received from the large language model and compared. If the responses are significantly different, an additional prompt with actual text from the webpage can be generated and provided to the large language model.

In this way, the described techniques allow for more effective use of a large language model in order to perform one or more functions related to a webpage. Among other things, the on-device machine learning model can be trained to effectively generate prompts for the large language model, where the prompts cause the large language model to provide desired information to a user. Moreover, the described techniques can support improved user privacy, such as by not using user profile information unless an opt-in is obtained or by not processing sensitive information from a webpage (such as account information, health information, financial information, or other private information associated with the user). In addition, the on-device machine learning model can be updated over time to provide improved results to the user, which can greatly increase user satisfaction.

Note that in the following discussion, it may often be assumed that the described techniques for prompt generation are used with specific types of consumer electronic devices (such as desktop or laptop computers, smartphones, tablet computers, and extended reality headsets). However, the described techniques for prompt generation may be used with any other suitable types of consumer electronic devices or other electronic devices. In general, this disclosure is not limited to use with any specific type(s) of electronic device(s). Also note that this disclosure is not limited to use with any particular large language model and that any suitable large language model or models may be used.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may be used to perform one or more functions related to prompt generation for a large language model using textual content, such as by generating prompts for a large language model executed on the server 106 and receiving responses from the large language model.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications for prompt generation for a large language model using textual content. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may be used to perform one or more functions related to prompt generation for a large language model using textual content, such as by receiving prompts for a large language model executed on the server 106 from the electronic device 101 and providing responses from the large language model to the electronic device 101.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

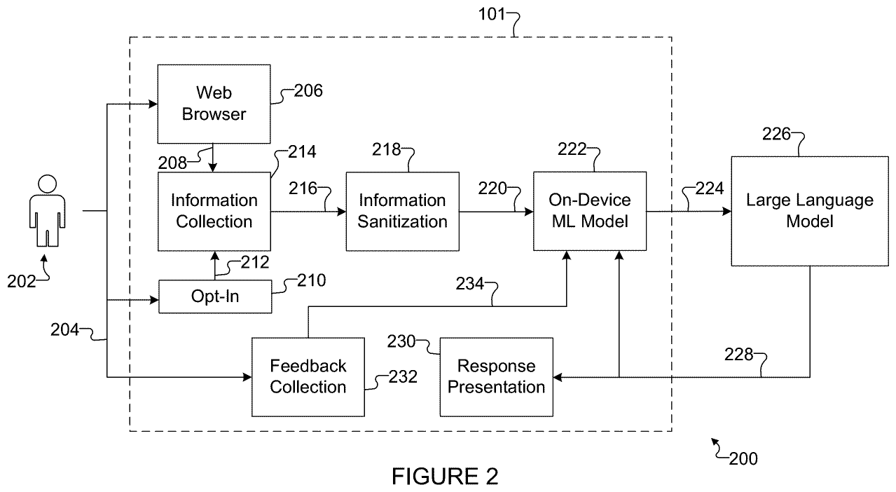

FIG. 2 illustrates an example architecture 200 for prompt generation for a large language model using textual content in accordance with this disclosure. For ease of explanation, the architecture 200 shown in FIG. 2 is described as being primarily implemented on or supported by the electronic device 101 in the network configuration 100 of FIG. 1. However, the architecture 200 shown in FIG. 2 could be used with any other suitable device(s) and in any other suitable system(s).

As shown in FIG. 2, the architecture 200 may primarily operate on or within the electronic device 101, which is associated with at least one user 202. The user 202 can submit various inputs 204 to the electronic device 101. These inputs 204 can relate to various operations performed by the electronic device 101, including (but not limited to) web browsing and prompt generation. The inputs 204 may be received from the user 202 in any suitable manner, such as via a physical or virtual keyboard or keypad, verbally, or in any other suitable manner.

In this example, the electronic device 101 includes a web browser 206, which represents an application that (among other things) allows the user 202 to “surf” the Internet and view different webpages. During use of the web browser 206, the web browser 206 can receive input 204 from the user 202, such as input 204 defining which webpages the user 202 wishes to visit and how the user 202 wants to interact with those webpages. During this time, the web browser 206 can generate or collect various information associated with the user's activities and the webpages viewed by the user 202, and that information may generally be referred to as a browsing context 208.

The browsing context 208 may include any suitable information associated with the user's activities and the webpages viewed by the user 202. For example, the web browser 206 can extract hypertext markup language (HTML) content or other content (such as text, images, and/or videos) from each webpage and identify the URL of each webpage, and the extracted information and the URL of each webpage can form at least part of the browsing context 208. The web browser 206 can also extract HTML metadata or other metadata from each webpage, and the metadata can form at least part of the browsing context 208. The metadata typically includes information about or related to a webpage that is not actually presented to the user 202 when that webpage is rendered. As particular examples, shopping websites routinely include metadata in each of their webpages identifying the specific products or services shown in their webpages. Search engines and other applications often use metadata for indexing or other purposes, and this metadata can be used by the architecture 200 to support prompt generation. In addition, the web browser 206 may maintain a browsing history associated with the user 202, and the browsing history can form at least part of the browsing context 208. The browsing history can identify webpages that are accessed by the web browser 206 and when those webpages are accessed. Note that the browsing context 208 may include one, some, or all of these types of information in the browsing context 208, possibly along with one or more additional types of information.

The web browser 206 includes any suitable application configured to receive HTML or other code, display webpages based on the HTML or other code, and allow the user 202 to interact with at least some of the webpages. There are various web browsers that are currently available for use, and additional web browsers are sure to be developed in the future. This disclosure is not limited to use with any specific web browser 206.

An opt-in function 210 may optionally be provided that allows user profile information 212 to be obtained from the user 202 and used by the architecture 200. The user profile information 212 may represent or include information about the user 202 that the user 202 may or may not want to be shared. The user profile information 212 may include various types of information about the user 202 and can range from more general information to more specific information. More general information about the user 202 might include the user's age, sex, gender, country of origin, citizenship, employment status, or religious affiliation. More specific information about the user 202 might include the user's name, address, or employer. The opt-in function 210 can receive input 204 from the user 202 indicating whether the user 202 wishes for his or her user profile information 212 to be used by the architecture 200. If the user 202 opts in, the user profile information 212 can be processed as described below. If the user 202 opts out, the user profile information 212 may not be provided for further processing by the architecture 200. The opt-in function 210 may use any suitable technique to request permission to use user profile information 212, such as by presenting a popup window and asking whether the user 202 wishes to permit use of his or her user profile information 212.

An information collection function 214 obtains various information to be used by the architecture 200 during prompt generation. Among other things, the information collection function 214 can collect the information in order to facilitate the identification of the context in which the user 202 is visiting one or more webpages. The context relates to the user's purpose in visiting one or more webpages presented by the web browser 206. For example, the user 202 may be interested in reading news articles, reading or posting social media content, shopping for products or services, researching one or more topics, or viewing one or more entertainment programs. The context of the user's activities can have a bearing on how a large language model is queried, and the information collection function 214 can be used to collect various information and output the information as prompt generation information 216, which can be used to identify the context and other information for generating prompts for a large language model. The information collection function 214 can also package or format the prompt generation information 216 for subsequent use.

As shown in this example, the information collection function 214 may receive the browsing context 208, the user profile information 212 (assuming the user 202 has opted in), and optionally any other information associated with the user 202 or the webpage(s) presented to the user 202. The information collection function 214 can also pre-process the obtained information in order to prepare the obtained information for further use. For example, the information collection function 214 may process content extracted from each webpage and remove irrelevant data, such as ads, menus, or buttons. Among other things, the remaining content from a webpage may be useful in determining a more granular context for the user's activities, such as when determining if the user 202 is attempting to buy a specific pair of shoes or other product or if the user 202 is researching a specific topic. The information collection function 214 may process the content extracted from each webpage and the metadata associated with each webpage in order to classify each webpage's type, such as by determining whether each webpage is associated with a shopping website, a news website, a social media website, an entertainment website, a research website, or other type(s) of website(s). The metadata can also be used to provide hints for the context of the webpage(s) being presented to the user 202. In addition, the information collection function 214 may process the user's browsing history contained in the browsing context 208, such as in order to determine the user's current intent. For instance, the information collection function 214 can analyze the user's browsing history to determine if the user is searching for a particular product or service to buy or is researching a type of product or service.

The prompt generation information 216 that is output by the information collection function 214 can include various information generated or collected by the information collection function 214. For example, the prompt generation information 216 can include information identifying the specific context associated with the user 202 and any user profile information 212 permitted to be used by the user 202. The prompt generation information 216 may optionally be provided to an information sanitization function 218, which can remove one or more types of personal or other sensitive data from the prompt generation information 216 and generate sanitized information 220. The information sanitization function 218 may be used to block any suitable type(s) of sensitive information from being further processed by the architecture 200. For instance, the information sanitization function 218 may determine whether a webpage being presented to the user 202 includes sensitive information, such as account information, health information, financial information, or other private information associated with the user 202. If detected, the information sanitization function 218 may block some or all of the sensitive information from being included in the sanitized information 220. Note that while sanitization is shown here as being performed after the information collection function 214, the information sanitization function 218 may be performed at any other or additional location(s) in the architecture 200.

The sanitized information 220 is provided to an on-device machine learning (ML) model 222, which processes the sanitized information 220 in order to generate one or more prompts 224 for at least one large language model 226. The machine learning model 222 is referred to as being “on-device” here since the machine learning model 222 is executed on the user's electronic device 101, rather than on a remote device (such as the server 106), which can help to provide improved user privacy. The large language model(s) 226 need not be executed on the user's electronic device 101 and may be remote from the electronic device 101, such as when one or more large language models 226 are executed by one or more servers 106.

The on-device machine learning model 222 here is trained to perform prompt engineering in order to generate suitable prompts 224 for the large language model(s) 226. Prompt engineering refers to the process of designing prompts for large language models or other generative artificial intelligence (AI) models that result in desired responses from the Al models. In the context of FIG. 2, the on-device machine learning model 222 generates prompts 224 that are provided to the large language model(s) 226 for use in generating responses 228, where the prompts 224 relate to specific actions that can be performed with respect to the webpages being presented to the user 202 by the electronic device 101.

In some embodiments, the on-device machine learning model 222 can be trained to generate prompts 224 for specific actions from within a set of recognized candidate actions, where the candidate actions relate to functions that can be performed involving the webpages being presented to the user 202. As an example, when the user 202 is viewing a specific webpage, the user 202 may wish to locate other content that is similar or related to the content of the webpage being viewed, in which case the user 202 might want to receive a list of other webpages that contain information similar or related to the information in the webpage being viewed by the user 202. As another example, the user 202 may wish to view a summary of the webpage being viewed by the user 202, such as when the user 202 wishes to read a summary of a news article or other content in the webpage without reading the entire webpage. As yet another example, the user 202 may wish to view the key points of the webpage being viewed by the user 202, such as when the user 202 wishes to read the key points of a news article or other content in the webpage without reading the entire webpage. As still another example, the user 202 may provide a question about the webpage that the user 202 wants answered, in which case the user 202 might want to receive an answer to the question based on the information in the webpage being viewed by the user 202 or from another webpage. All of these are examples of candidate actions that might be invoked by the user 202. In particular embodiments, the set of candidate actions may be predefined and limited to a specific collection of actions that can be performed, which can help to keep the size and inferencing time of the on-device machine learning model 222 relatively low.

When the user 202 requests that an action from among the set of candidate actions be performed, the on-device machine learning model 222 can generate at least one prompt 224 that identifies the selected action and that includes at least some of the information 216, 220. To generate a prompt 224, the on-device machine learning model 222 can process (among other things) the information related to the user's browsing context 208. For instance, as noted above, the on-device machine learning model 222 can use the type of webpage being accessed (such as shopping, news, social media, entertainment, research, etc.) to determine how to phrase a prompt 224. Note that the type of the webpage being accessed by the user 202 may be identified in any suitable manner. In some cases, for example, the on-device machine learning model 222 may be trained to identify the type of webpage being accessed. In other cases, the on-device machine learning model 222 may provide the content or the URL of a webpage to a large language model 226 and ask the large language model 226 to categorize the webpage.

The on-device machine learning model 222 can also use the primary content of the webpage being viewed by the user 202 and the metadata (such as title and description) of the webpage being viewed by the user 202 to generate a prompt 224. For instance, the on-device machine learning model 222 may locate specific useful keywords in the webpage or its metadata and include those specific keywords in the prompt 224 being generated. In addition, the on-device machine learning model 222 can use the user profile information 212 (if available) to tailor a prompt 224. As an example, the user's age, sex, gender, or a combination thereof may be used by the on-device machine learning model 222 to tailor the prompt 224 to search for appropriate products or services, such as suitable clothing items or other personal items. As another example, the user's age may be included in a prompt 224 so that the large language model 226 can generate a response 228 that is suitable given the user's age, such as when the large language model 226 phrases the answer to a question in different ways depending on the age of the user 202.

Each prompt 224 provided to the large language model 226 causes the large language model 226 to generate a response 228. Each response 228 can be provided to a response presentation function 230, which can present the response 228 to the user 202. For example, the response presentation function 230 may cause the display 160 of the electronic device 101 to display the response 228, or the response presentation function 230 may cause a speaker of the electronic device 101 to audibly play the response 228. The response presentation function 230 may present each response 228 to the user 202 in any suitable manner. Also, the manner in which each response 228 is presented may vary based on the type of electronic device 101 being used, such as when the presentation varies depending on whether the electronic device 101 is a desktop/laptop computer, smartphone/tablet computer, or extended reality (XR) device (such as a virtual reality, augmented reality, or mixed reality headset or glasses). Each response 228 can also be provided to the on-device machine learning model 222 for use, such as when the on-device machine learning model 222 analyzes a response 228 to determine whether the response 228 appears to be responsive to the user's request. If not, the on-device machine learning model 222 may prevent the response presentation function 230 from presenting the response 228 and may generate a different prompt 224 for the large language model 226.

In this example, a feedback collection function 232 can be used to generate feedback on the quality of one or more responses 228 received from the large language model 226. For example, the feedback collection function 232 can identify how the user 202 interacts with each response 228 that is presented to the user 202. The user 202 may interact with each response 228 in various ways, and the ways in which the user 202 interacts with each response 228 can be used to derive a measure of the quality of each response 228. Some of the ways in which the user 202 interacts with each response 228 may be positive, and some of the ways in which the user 202 interacts with each response 228 may be negative.

As a particular example of this, if the user 202 copies part of all of the content included in a response 228 (such as for pasting elsewhere), this may be a positive indicator that the user 202 liked the response 228 or found the response 228 useful. Similarly, if the user 202 spends a significant amount of time reading a response 228 (such as an amount of time that is greater than a threshold, which in some cases may be based on the quantity of information in the response 228), this may be a positive indicator that the user 202 liked the response 228 or found the response 228 useful. If the user 202 clicks on one or more URLs or other links included in a response 228, this may be a positive indicator that the user 202 liked the response 228 or found the response 228 useful. If the electronic device 101 provides a mechanism for rating responses 228, a higher user rating can be indicative of a useful response 228. In contrast, if the user 202 does not copy any content included in a response 228, does not spend much time reading a response 228, does not click on one or more URLs or other links included in a response 228, or provides a lower user rating, this can be indicative of an unhelpful response 228. The user 202 might also be presented with two or more responses 228 generated using two or more prompts 224 and be asked to identify which of the responses 228 is useful (if any) or whether each individual response 228 is good or bad. In these cases, the two or more prompts 224 may be provided to the same large language model 226 or to different large language models 226. The feedback collection function 232 may also determine how often the user 202 uses the prompt generation functionality of the architecture 200, which can provide a measure of the overall satisfaction of the user 202 with the prompt generation functionality.

Based on the derived feedback, feedback information 234 may be provided to the on-device machine learning model 222, where the feedback information 234 can be used to improve the operation of the on-device machine learning model 222. In some cases, for instance, the feedback information 234 may be used to update one or more weights of the on-device machine learning model 222 based on how the user 202 interacts with one or more responses 228 presented to the user 202. For example, features used to generate prompts 224 that resulted in responses 228 determined to be more positively-received by the user 202 could be weighted more, while features used to generate prompts 224 that resulted in responses 228 determined to be more negatively-received by the user 202 could be weighted less. Among other things, this may allow the on-device machine learning model 222 to be updated over time to generate prompts 224 that provide improved responses 228 or responses 228 with improved feedback. If the architecture 200 is used to generate prompts 224 for multiple large language models 226, this may also allow the on-device machine learning model 222 to be updated over time to generate prompts 224 that provide improved responses 228 or responses 228 with improved feedback for each of the large language models 226. This may help to fine-tune the on-device machine learning model 222 for use with one or more large language models 226. The feedback information 234 may also or alternatively be used by the on-device machine learning model 222 during generation of the prompts 224. For example, the on-device machine learning model 222 may use positive or negative feedback included in the feedback information 234 to determine whether certain phrasings of prompts 224 result in better or worse responses 228 that are received from the large language model(s) 226.

Depending on the circumstances and the implementation, the on-device machine learning model 222 may generate a single prompt 224 or multiple prompts 224 for each user request, and the on-device machine learning model 222 may provide the prompt(s) 224 to a single large language model 226 or to multiple large language models 226. For example, in some cases, the on-device machine learning model 222 may generate one prompt 224 for a single large language model 226 for a user request, or the on-device machine learning model 222 may generate multiple prompts 224 (such as a series of prompts 224) for a single large language model 226 for a user request. A series of prompts 224 might be useful, for instance, to help guide the large language model 226 to generating a suitable response 228. In other cases, the on-device machine learning model 222 may generate one or more prompts 224 for each of multiple large language models 226, and the responses 228 from the large language models 226 may be compared, combined, separately presented, or used in any other suitable manner.

The on-device machine learning model 222 can generate any suitable prompts 224 for use with the large language model(s) 226. In some embodiments, each prompt 224 may include a verb (based on user intent) and webpage-related information. The verb may represent or be based on one of the candidate actions that a large language model 226 is able to perform. The webpage-related information may include a URL, text or other content extracted from a webpage, metadata associated with a webpage, or other information. In some cases, the verbs that are available for use may be predefined, such as when certain verbs are identified based on market research or common Internet-browsing use cases. There can also be multiple verbs that are similar to one another (meaning they are synonyms), but different verbs may lead to different responses 228 from the large language model(s) 226. The on-device machine learning model 222 may operate to select the best verb for use in a prompt 224 based on the user's current browsing context 208 and other information.

As a particular example of selecting a verb for use in a prompt 224, the on-device machine learning model 222 may map the context of a webpage to a specific verb or group of verbs. Thus, for instance, a shopping webpage may be mapped to one verb or group of verbs, a news website may be mapped to another verb or group of verbs, and so on. This can help to build associations between different browsing contexts and different verbs. Based on the user's current browsing context 208 or other information, multiple verbs (actions) might be identified, in which case the verbs could be ranked based on the user's current browsing context 208 or other information. Any suitable technique may be used to map the context of a webpage to a specific verb or group of verbs. Example techniques that may be used here could include determining cosine similarities or other similarity measures between the context of a webpage and specific verbs/groups of verbs, using a clustering algorithm to cluster contexts and verbs/groups of verbs (such as by using word2vec or other vector generation algorithm with a random forest, k-means clustering, or other grouping algorithm), using a Global Vectors (GloVe) for Word Representation technique, or using Latent Dirichlet allocation to identify topics.

The on-device machine learning model 222 may also use any suitable technique to rank verbs that might be used in a prompt 224, and the ranking can be based on the user's current browsing context 208 or other information. For example, the verb “summarize” may be applied to virtual every webpage. However, if the user's current browsing context 208 indicates that the user 202 is researching a particular topic that the user 202 may have little knowledge of (such as while writing a research paper), another verb like “explain” (such as in the phrase “explain this like I'm [x] years old”) can be ranked higher than “summarize” if the user 202 is more likely to choose this action. This is useful, for instance, in order to generate a summary of a webpage that is more easily understandable than a summary containing jargon, which the user 202 may not understand.

As another example, based on the user's browsing history, it may be determined that the user 202 is searching about a product for which he or she wants more information, such as when the user 202 has searched “what kind of caulk to use for granite” using the web browser 206. The search results may include various product discussions and shopping sites for the product. However, the user's browsing history may show that the user 202 has been viewing various product sites and blogging sites to try and find the best caulk. Based on this, the on-device machine learning model 222 may determine that the user 202 is doing research (rather than shopping) at the moment and may suggest an action related to research and reviews, thereby ranking this action higher than a shopping action.

The on-device machine learning model 222 represents any suitable machine learning model that is trained to generate prompts 224 for one or more large language models 226, and the on-device machine learning model 222 can include any suitable machine learning architecture. As a particular example, in some embodiments, the on-device machine learning model 222 may include an embedding layer that generates embeddings of predefined keywords, as well as a recurrent neural network (such as seq2seq) or other neural network or machine learning layer(s) that process(es) the embeddings. The on-device machine learning model 222 may also include an output layer that generates a specific verb to be included in a prompt 224 and another output layer that creates a complete prompt 224 for input to a large language model 226. The complete prompt 224 may include the specific verb, text or other content from the webpage being viewed by the user 202, or any other or additional information. Note, however, that this implementation of the on-device machine learning model 222 is an example only and that the on-device machine learning model 222 may be implemented in any other suitable manner. The on-device machine learning model 222 may also be trained in any suitable manner. In some cases, training data may include multiple users' browsing histories, as well as at least one dataset (such as from wordnet.princeton.edu) that includes nouns, verbs, adjectives, and adverbs that are grouped into sets of cognitive synonyms (called “synsets”) each expressing a distinct concept.

Each large language model 226 may represent any suitable large language model or other natural language-based generative Al model. Numerous large language models are being developed and placed into use, and any suitable large language model(s) 226 may be used here. In general, this disclosure is not limited to use with any specific large language model or models 226. It should also be noted here that one or more large language models 226 can be effectively used to perform functions related to webpages being viewed by the user 202, such as to identify similar or related content for a webpage, generate a summary of a webpage, identify key points of a webpage, or answer questions about a webpage. This is because large language models 226 generally require massive amounts of training data, which in many cases involves using data from the Internet. This makes large language models 226 trained with Internet-based data very useful in enhancing user experiences while navigating webpages accessible via the Internet.

Although FIG. 2 illustrates one example of an architecture 200 for prompt generation for a large language model 226 using textual content, various changes may be made to FIG. 2. For example, various components and functions in FIG. 2 may be combined, further subdivided, replicated, rearranged, or omitted according to particular needs. Also, one or more additional components and functions may be included in FIG. 2 if needed or desired.

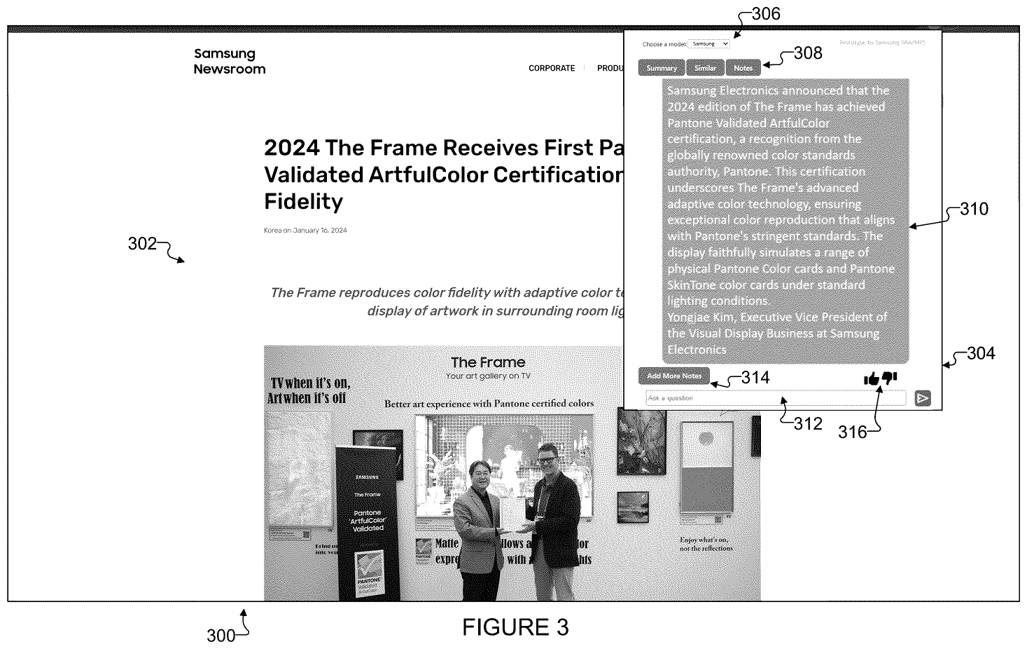

FIGS. 3 through 6 illustrate example uses of prompt generation for a large language model 226 using textual content in accordance with this disclosure. For ease of explanation, the uses shown in FIGS. 3 through 6 are described as being primarily implemented on or supported by the electronic device 101 in the network configuration 100 of FIG. 1 using the architecture 200 of FIG. 2. However, these uses are examples only, and the architecture 200 may be used in any other suitable manner.

As shown in FIG. 3, a display 300 may be presented on an electronic device 101, such as a desktop computer, laptop computer, or larger tablet computer. The display 300 can be presented using the web browser 206, where the display 300 includes a webpage 302. The web browser 206 may include a menu bar, a toolbar, or other or additional mechanisms for receiving user input, such as user input invoking one or more functions of the web browser 206. As can be seen here, the user 202 has invoked the prompt generation functionality of the architecture 200, which causes a popup window 304 to be presented within the display 300.

In this example, the popup window 304 includes a dropdown menu 306 that allows the user 202 to select a specific large language model 226 for use. Note, however, that the large language model 226 to be used may be identified in any other suitable manner, such as in other settings of the web browser 206 or the electronic device 101 or when a default large language model 226 is used. The popup window 304 also includes various buttons 308 that allow the user 202 to select a particular action from among a set of candidate actions, each of which relates to the webpage 302 being presented. Here, the buttons 308 allow the user 202 to view a summary of the information in the webpage 302, view similar information as the information in the webpage 302, or see notes (such as key points) related to the information in the webpage 302.

When the user 202 selects one of the buttons 308, the architecture 200 generates a prompt 224 based on the selected action and the content of the webpage 302, provides the prompt 224 to the large language model 226, and receives a response 228 from the large language model 226. A response presentation area 310 can present the response 228 to the user. In this example, the user 202 has selected the summary button 308, and the response presentation area 310 includes text summarizing the content of the webpage 302 received from the large language model 226.

The popup window 304 may also include a text box 312 in which the user 202 is able to ask questions about the webpage 302. For example, the user 202 may type, speak, or otherwise provide a question into the text box 312. The architecture 200 can use the content of the text box 312 to generate a prompt 224 that is provided to the large language model 226 for answer generation, and the answer can be presented in the response presentation area 310. In some cases, the format of questions and answers in the response presentation area 310 may appear to take the form of a chat session, such as when text from the user is in one color and positioned on one side of the response presentation area 310 and text from the large language model 226 is in another color and positioned on the opposite side of the response presentation area 310. The popup window 304 may further include a button 314 that allows the user 202 to add one or more key points or other notes regarding the webpage 302.

In addition, the popup window 304 may include a feedback mechanism 316 that allows the user 202 to rate each response 228 presented in the response presentation area 310. As described above, this feedback can be used to adjust weights of the on-device machine learning model 222 or perform other feedback-related operations. In this example, the feedback mechanism 316 includes a “thumbs up” icon and a “thumbs down” icon, each of which can be selected by the user 202 in order to rate the quality of a response 228. However, this form of the feedback mechanism 316 is for illustration only, and any other suitable feedback mechanism 316 (such as one based on stars, a sliding scale, or other indicator) may be used.

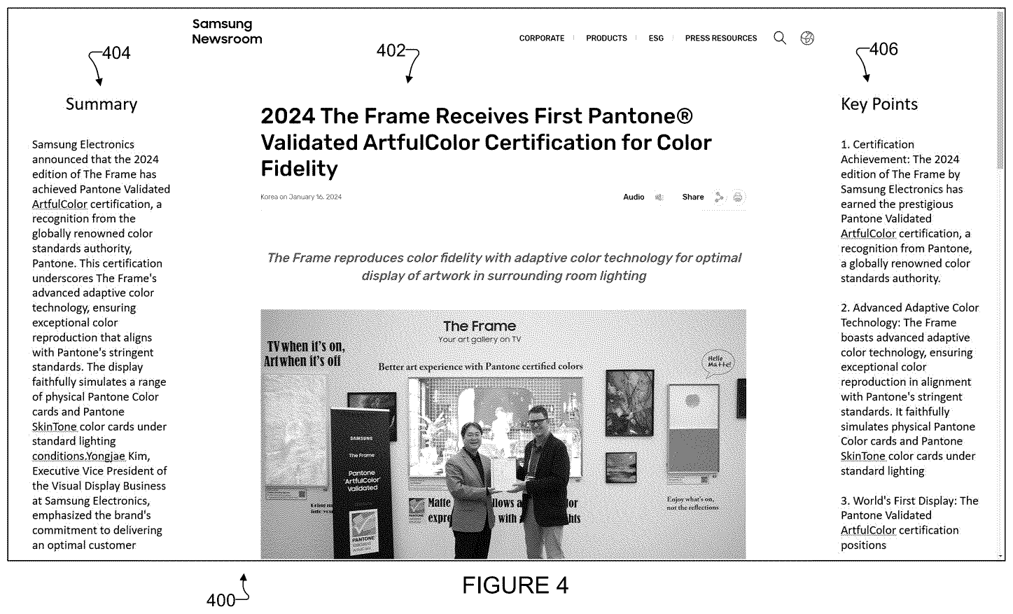

In the example of FIG. 3, one or more responses 228 are presented to the user 202 in a popup window. In contrast, as shown in FIG. 4, a display 400 similar to the display 300 is being presented using the web browser 206, where the display 400 includes a webpage 402. In this example, however, one or more response presentation areas 404, 406 can be generated using the architecture 200 and positioned next to the webpage 402 (without overlapping the webpage 402 much if at all). This type of approach can allow the user 202 to view the webpage 402 and the contents of the response presentation areas 404, 406.

In some cases, the contents of the response presentation areas 404, 406 may be generated automatically without waiting for a user request. For example, when the user 202 navigates to the webpage 402, the architecture 200 may generate a prompt 224 that asks a large language model 226 to summarize the webpage 402 and another prompt 224 that asks a large language model 226 to identify the key points of the webpage 402. The corresponding responses 228 may be automatically presented in the response presentation areas 404, 406. This type of approach might be useful, for instance, when the architecture 200 determines the webpage 402 is a particular type of webpage for which the user 202 might want to view the summary, key points, or other AI-based content. In some cases, this can be a learned behavior, such as when the on-device machine learning model 222 determines that the user 202 routinely asks for a summary, key points, or other AI-based content when visiting news websites or other types of websites.

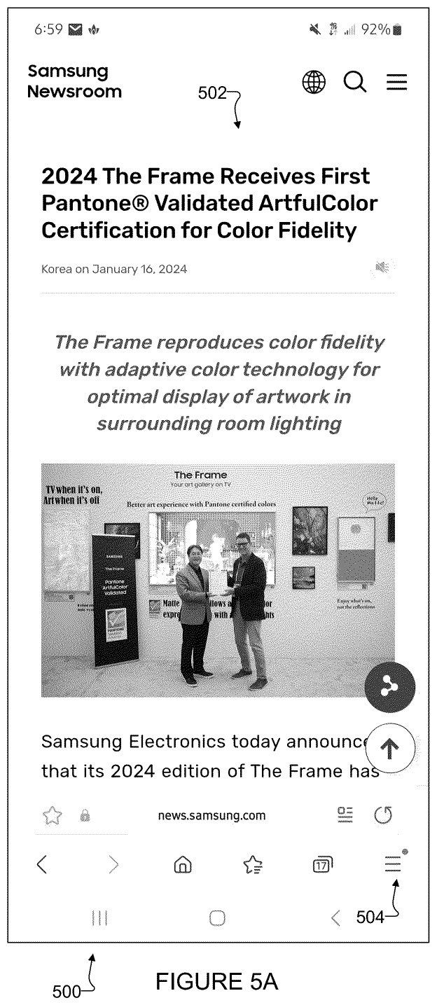

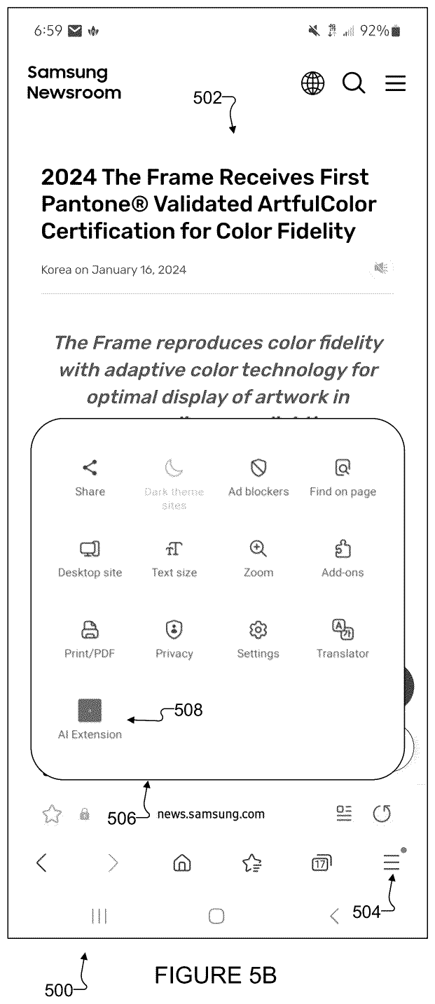

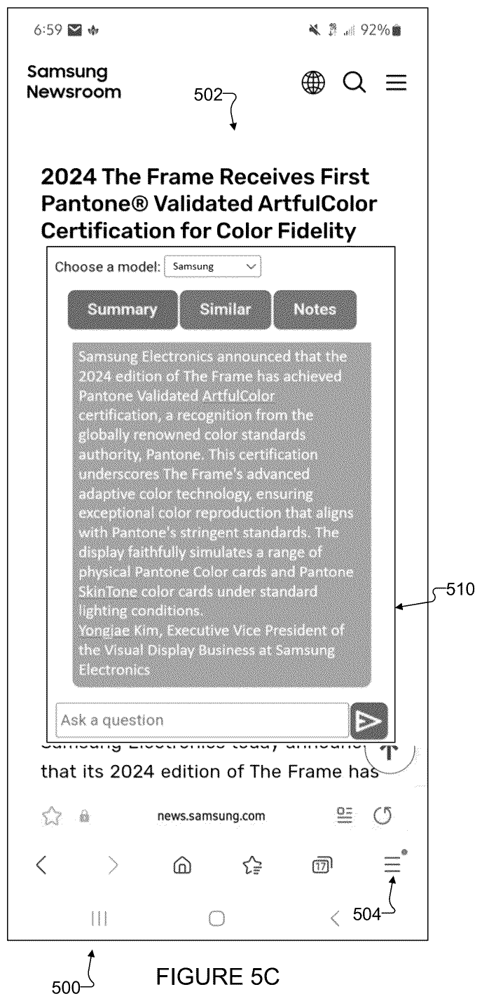

As shown in FIGS. 5A through 5C, a display 500 may be presented by the web browser 206 on a mobile electronic device 101, such as a smartphone or a smaller tablet computer. In FIG. 5A, the display 500 is presenting a webpage 502, and the display 500 includes various controls, such as a settings control 504. When the user 202 selects the settings control 504, a popup window 506 as shown in FIG. 5B can be presented. The popup window 506 includes an “Al” option 508, which can be used to invoke the functionality of a large language model 226. When the “Al” option 508 is selected, a popup window 510 as shown in FIG. 5C can be presented. The popup window 510 may be the same as or similar to the popup window 304 shown in FIG. 3. Note that while the popup window 510 here lacks the button 314 and the feedback mechanism 316, one or both may be included in the popup window 510.

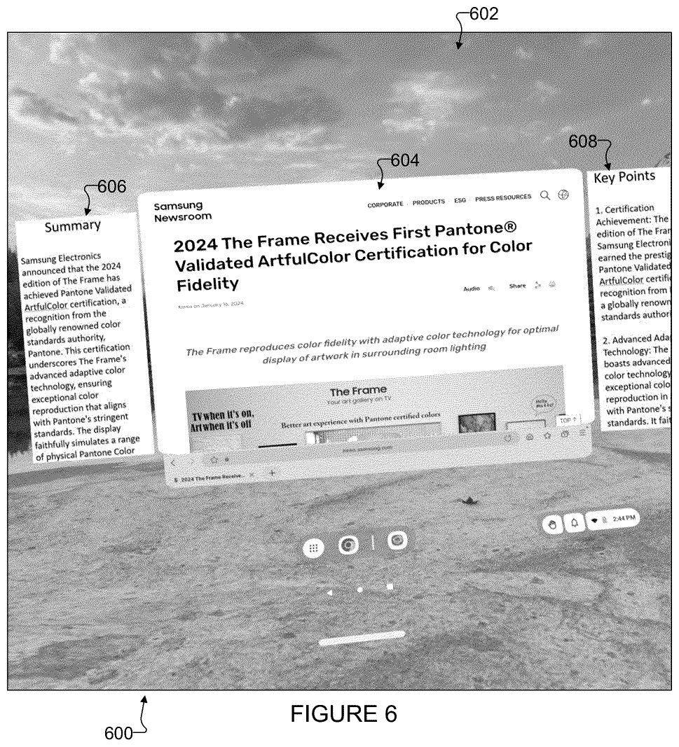

As shown in FIG. 6, a display 600 may be presented by the web browser 206 on an XR electronic device 101, such as a virtual reality, augmented reality, or mixed reality headset or glasses. In FIG. 6, the display 600 is presenting a real or virtual scene 602 to the user 202, and a webpage 604 is displayed over or within the scene 602. One or more response presentation areas 606, 608 (which may be the same as or similar to the response presentation areas 404, 406) can be generated (possibly automatically) using the architecture 200 and presented within the display 600. Note, however, that the display 600 may also or alternatively be used to present a popup window to the user 202, such as a popup window 304 or 510 described above. In this example, the user 202 may use one or more gestures, spoken commands, or other inputs to show/hide the response presentation areas 606, 608, invoke prompt generation, or perform other functions.

Although FIGS. 3 through 6 illustrate examples of uses of prompt generation for a large language model using textual content, various changes may be made to FIGS. 3 through 6. For example, while certain input/output mechanisms like dropdown menus, buttons, and text boxes are shown here, any suitable input/output mechanisms may be used to obtain information from or provide information to the user 202. Also, while FIGS. 3 through 6 illustrate example ways in which prompt generation may be used, the described techniques for prompt generation may be used in any other suitable manner. FIGS. 3 through 6 do not limit the scope of this disclosure to the specific presentations, input/output mechanisms, and other features shown in the specific examples of FIGS. 3 through 6.

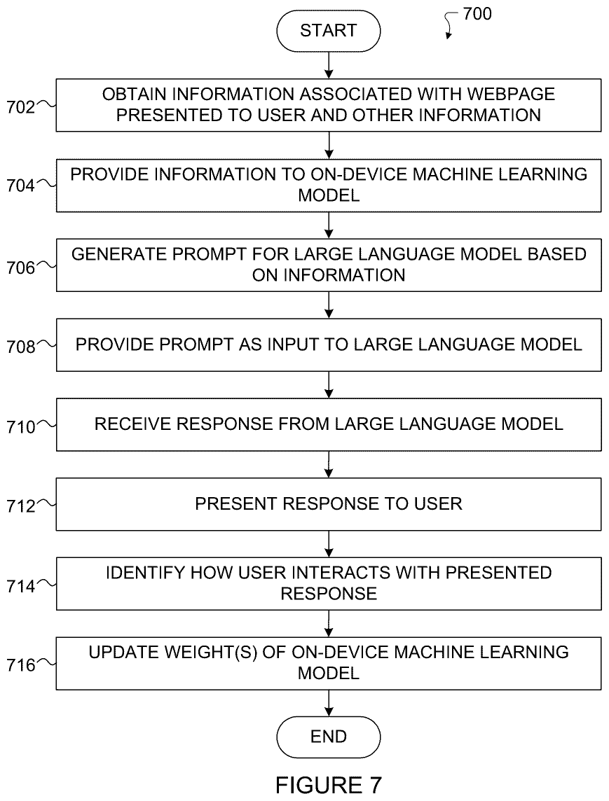

FIG. 7 illustrates an example method 700 for prompt generation for a large language model using textual content in accordance with this disclosure. For ease of explanation, the method 700 shown in FIG. 7 is described as being implemented on or supported by the electronic device 101 in the network configuration 100 of FIG. 1 using the architecture 200 of FIG. 2. However, the method 700 shown in FIG. 7 could be used with any other suitable device(s) and in any other suitable system(s).

As shown in FIG. 7, information associated with a webpage presented to a user and optionally other information are obtained at step 702. This may include, for example, the processor 120 of the electronic device 101 performing the information collection function 214 to obtain a browsing context 208 and optionally user profile information 212. In some cases, the browsing context 208 may include content from the webpage presented to the user 202, a URL of the webpage presented to the user 202, metadata associated with the webpage presented to the user 202, and/or a browsing history associated with the user 202.

At least some of the information is provided to an on-device machine learning model at step 704. This may include, for example, the processor 120 of the electronic device 101 passing at least some of the browsing context 208 and optionally at least some of the user profile information 212 to the on-device machine learning model 222. In some cases, the processor 120 of the electronic device 101 may perform the information sanitization function 218 in order to remove sensitive information and generate sanitized information 220, where at least some of the sanitized information 220 is provided to the on-device machine learning model 222. This may prevent sensitive information from being provided to the on-device machine learning model 222 and/or included in a prompt 224.

At least one prompt for a large language model is generated using the on-device machine learning model at step 706. This may include, for example, the processor 120 of the electronic device 101 using the on-device machine learning model 222 to process the information provided to the on-device machine learning model 222 in order to generate at least one prompt 224 for at least one large language model 226. The prompt 224 can include (i) an action from a set of candidate actions that a large language model 226 is able to perform and (ii) at least some of the information provided to the on-device machine learning model 222. As a particular example, the candidate actions may include locating content related to the webpage, generating a summary of the webpage, identifying one or more key points of the webpage, and answering a user question about the content of the webpage (or any combination thereof). Also, as a particular example, the on-device machine learning model 222 can map the information to a verb or set of verbs and (if multiple verbs are available) rank the verbs based on the browsing context 208 in order to select a verb for use in the prompt 224. The on-device machine learning model 222 can also insert content from the webpage, the webpage URL, or any other or additional information that might be used by the large language model(s) 226 into the prompt 224.

The at least one prompt is provided to the at least one large language model at step 708. This may include, for example, the processor 120 of the electronic device 101 communicating the prompt(s) 224 to the large language model(s) 226, such as one or more large language models 226 available on one or more servers 106. A response to each prompt is received from the large language model(s) at step 710, and each response may be presented to the user at step 712. This may include, for example, the processor 120 of the electronic device 101 performing the response presentation function 230 in order to display each response 228 on a display 160 of the electronic device 101 or to otherwise provide each response 228 to the user 202. As described above, in some cases, the on-device machine learning model 222 may analyze each response 228 prior to presentation, such as to determine whether the response 228 appears to be responsive to the user request.

Optionally, the electronic device can identify how the user interacts with each response at step 714 and, if needed or desired, update one or more weights of the on-device machine learning model at step 716. This may include, for example, the processor 120 of the electronic device 101 performing the feedback collection function 232 to determine how the user 202 interacts with each response 228, such as by determining whether the user 202 copies content included in a response 228, determining a time that the user 202 spends viewing a response 228, and/or determining how the user 202 rates the response. This may also include the processor 120 of the electronic device 101 updating one or more weights of the on-device machine learning model 222 based on the determination, such as to more heavily weight prompt generation techniques or prompt phrasings that result in more-favorable responses 228 being obtained from the large language model(s) 226.

Although FIG. 7 illustrates one example of a method 700 for prompt generation for a large language model using textual content, various changes may be made to FIG. 7. For example, while shown as a series of steps, various steps in FIG. 7 may overlap, occur in parallel, occur in a different order, or occur any number of times (including zero times). As a particular example, the use of feedback may be optional, in which case steps 714 and 716 may be omitted.

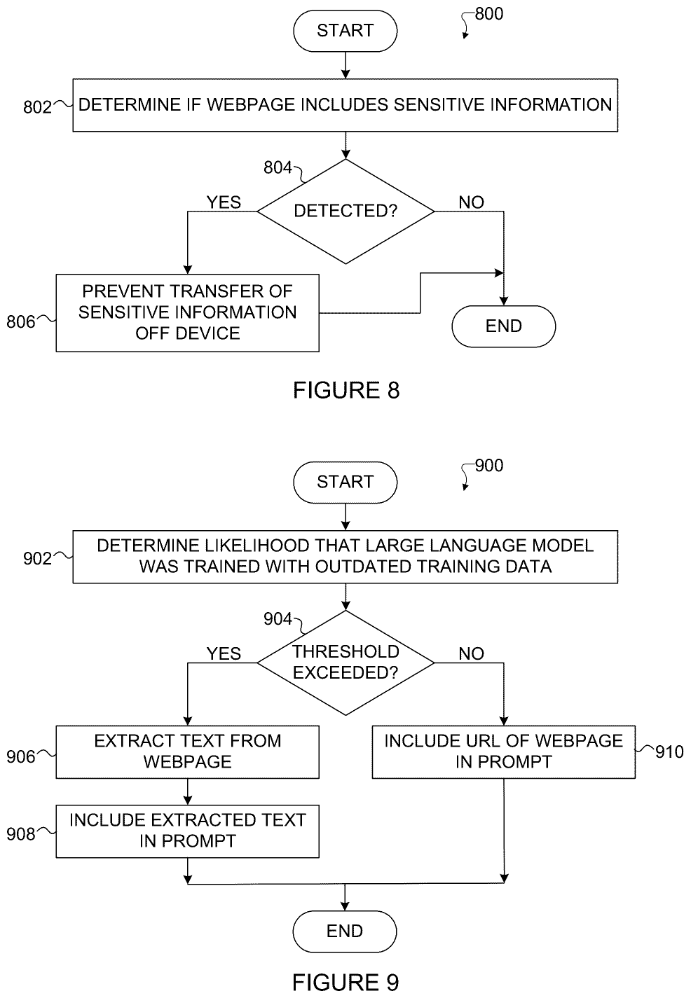

FIGS. 8 through 10 illustrate example methods 800, 900, 1000 that may supplement prompt generation for a large language model using textual content in accordance with this disclosure. More specifically, the methods 800, 900, 1000 may be used as part of the method 700 of FIG. 7 or may replace or supplement one or more operations in the method 700 of FIG. 7.

The method 800 of FIG. 8 may be performed as part of the information collection in step 702, as part of the prompt generation in step 706, or at other times in the method 700. As shown in FIG. 8, a determination is made whether a webpage being presented to a user contains sensitive information at step 802. This may include, for example, the processor 120 of the electronic device 101 performing the information sanitization function 218 in order to identify sensitive information in or associated with a webpage presented to the user 202 or to identify a sensitive webpage presented to the user 202. The sensitive information may include, for instance, account information, health information, financial information, or other private information associated with the user 202. As a particular example, the sensitive information may include bank account or credit card statements. The presence of sensitive information may be determined in any suitable manner, such as by using the URL or metadata of the webpage presented to the user 202 or by using a list of known websites or URLs from which the architecture 200 is not permitted to extract or use content.

If sensitive information is detected at step 804, the transfer of the sensitive information off the electronic device is prevented at step 806. This may include, for example, the processor 120 of the electronic device 101 preventing the sensitive information from being included in the sanitized information 220 provided to the on-device machine learning model 222 and/or preventing the sensitive information from being included in the prompt(s) 224 generated by the on-device machine learning model 222. As a particular example, this may include the processor 120 of the electronic device 101 using an on-device machine learning model 222 that has been trained to ignore or exclude certain types of sensitive information from prompts 224.

The method 900 of FIG. 9 may be performed as part of the prompt generation in step 706. As shown in FIG. 9, a likelihood that a large language model to be used to perform a desired function was trained using training data that is now outdated can be determined at step 902. This may include, for example, the processor 120 of the electronic device 101 using the on-device machine learning model 222 to determine if the large language model 226 to be used to process a prompt 224 was trained using Internet-based data up to a certain point in time that is now too far in the past and lacks an ability to access webpages on its own. As a particular example, metadata or other data from a webpage may indicate when the webpage was published, and this date can be compared to the date at which data used for training a large language model 226 stopped being collected or used.

If the likelihood exceeds a threshold at step 904, content from the webpage can be extracted at step 906 and included in the prompt being generated at step 908. Otherwise, a URL of the webpage can be included in the prompt at step 910. This approach may be based on the assumption that some large language models 226 are trained up to a certain point in time and cannot access webpages as part of their inferencing processes, while other large language models 226 are trained up to a certain point in time and have the ability to access webpages as part of their inferencing processes. Thus, if the likelihood exceeds the threshold at step 904, this can indicate that content (such as text) from the webpage should be included in the prompt 224 for use by the large language model 226, which assumes the large language model 226 lacks the ability to access the webpage's URL. The URL itself may be omitted from the prompt 224, which can be useful since some large language models 226 may use the contents of the URL itself in an attempt to generate a response 228. This can lead to hallucinations or other incorrect information being included in the response 228. If the likelihood does not exceed the threshold at step 904, the large language model 226 can have the ability to access the webpage's URL, so providing the URL in the prompt 224 may be sufficient (although the text or other content from the webpage might still be included in the prompt 224 in some cases).

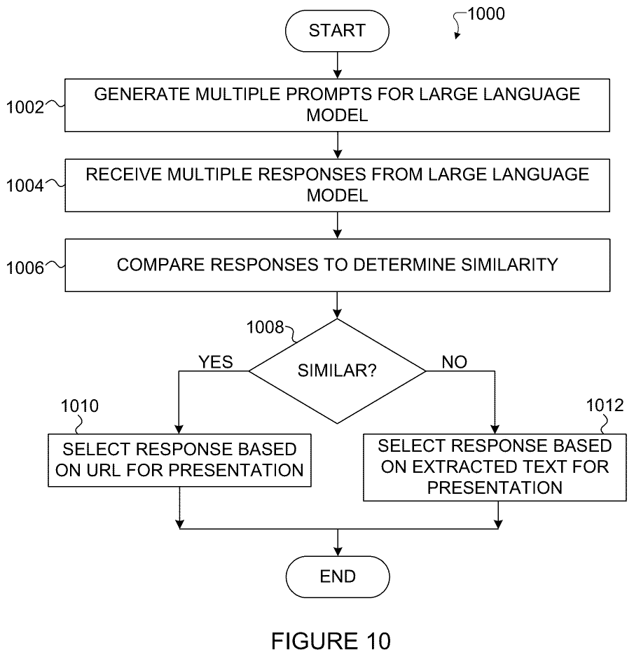

The method 1000 may be performed as part of the prompt generation in step 706 and response receipt at step 710. As shown in FIG. 10, multiple prompts for at least one large language model are generated at step 1002, and multiple responses to those prompts are received from the large language model(s) at step 1004. This may include, for example, the processor 120 of the electronic device 101 using the on-device machine learning model 222 to process the information provided to the on-device machine learning model 222 in order to generate at least a first prompt 224 and a second prompt 224, which can be provided to at least one large language model 226 in order to receive at least a first response 228 and a second response 228. The first prompt 224 may include text or other content extracted from the webpage being presented to the user 202, and the second prompt 224 may include a URL of the webpage being presented to the user 202.

The responses are compared in order to determine their similarity at step 1006. This may include, for example, the processor 120 of the electronic device 101 determining the similarity of the responses 228 using cosine similarity or other measure of similarity. If a determination is made that the responses are adequately similar (such as when the measure of similarity exceeds a threshold) at step 1008, the response based on the URL may be selected for presentation to the user at step 1010. Otherwise, the response based on the text may be selected for presentation to the user at step 1012. This can be based on the assumption that the URL may be used by some large language models 226 to gather more useful data than just using the content of the webpage. However, as noted above, other large language models 226 might lack the ability to access webpages and might instead use the URL itself as part of its inferencing (which could lead to hallucinations). Providing both text and the URL to a large language model 226 should cause the large language model 226 to return similar results if the large language model 226 can actually access the webpage's URL. In that case, use of the response 228 based on the URL may be desired. If not, use of the response 228 based on the extracted text may be desired.

Although FIGS. 8 through 10 illustrate examples of methods 800, 900, 1000 that may supplement prompt generation for a large language model 226 using textual content, various changes may be made to each of FIGS. 8 through 10. For example, while shown as a series of steps, various steps in each of FIGS. 8 through 10 may overlap, occur in parallel, occur in a different order, or occur any number of times (including zero times). Also, sensitive information may be excluded from use in any other suitable manner or used. In addition, handling out-of-date or other types of large language models 226 may not be needed, such as when the large language model 226 being used is known to be up-to-date or capable of using URLs to access webpages.

It should be noted that the functions shown in or described with respect to FIGS. 2 through 10 can be implemented in an electronic device 101, server 106, or other device in any suitable manner. For example, in some embodiments, at least some of the functions shown in or described with respect to FIGS. 2 through 10 can be implemented or supported using one or more software applications or other software instructions that are executed by the processor 120 of the electronic device 101, server 106, or other device. In other embodiments, at least some of the functions shown in or described with respect to FIGS. 2 through 10 can be implemented or supported using dedicated hardware components. In general, the functions shown in or described with respect to FIGS. 2 through 10 can be performed using any suitable hardware or any suitable combination of hardware and software/firmware instructions. Also, the functions shown in or described with respect to FIGS. 2 through 10 can be performed using any number of devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, information associated with a webpage presented to a user;
providing, using the at least one processing device, the information to an on-device machine learning model of the electronic device;
generating, using the on-device machine learning model, a prompt for a large language model based on the information, the prompt including (i) an action from a set of candidate actions that the large language model is able to perform and (ii) at least some of the information;
providing, using the at least one processing device, the prompt as input to the large language model;
receiving, using the at least one processing device, a response from the large language model; and
presenting, using the at least one processing device, the response to the user.

2. The method of claim 1, wherein the set of candidate actions comprises at least one of:
locating content related to the webpage;
generating a summary of the webpage;
identifying one or more key points of the webpage; or
answering a user question about the content of the webpage.

3. The method of claim 1, wherein:
the information associated with the webpage comprises webpage metadata associated with the webpage;
the method further comprises obtaining a browsing history associated with the user and profile information associated with the user;
the prompt is generated based on the browsing history, the profile information, and the webpage metadata.

4. The method of claim 1, further comprising:
identifying how the user interacts with the presented response; and
updating one or more weights of the on-device machine learning model based on how the user interacts with the presented response.

5. The method of claim 4, wherein identifying how the user interacts with the presented response comprises at least one of:
determining whether the user copies content included in the response;
determining a time that the user spends viewing the response; or
determining how the user rates the response.

6. The method of claim 1, wherein generating the prompt comprises:
determining a likelihood that the large language model was trained using outdated training data; and
one of:
in response to the likelihood exceeding a threshold, extracting text from the webpage and including the text in the prompt; or
in response to the likelihood not exceeding the threshold, including a uniform resource locator (URL) associated with the webpage in the prompt.

7. The method of claim 1, further comprising:
determining whether the webpage includes sensitive information; and
in response to determining that the webpage includes sensitive information, at least one of: not providing the sensitive information to the on-device machine learning model or not including the sensitive information in the prompt.

8. The method of claim 1, wherein:
the prompt comprises a first prompt;
the response comprises a first response; and
the method further comprises:
generating a second prompt for the large language model based on the information, the second prompt phrased differently than the first prompt;
providing the second prompt as input to the large language model;
receiving a second response from the large language model;
comparing the first and second responses; and
selecting one of the first and second responses for presentation to the user.

9. An electronic device comprising:
at least one processing device configured to:
obtain information associated with a webpage presented to a user;
provide the information to an on-device machine learning model of the electronic device;
generate, using the on-device machine learning model, a prompt for a large language model based on the information, the prompt including (i) an action from a set of candidate actions that the large language model is able to perform and (ii) at least some of the information;
provide the prompt as input to the large language model;
receive a response from the large language model; and
present the response to the user.

10. The electronic device of claim 9, wherein the set of candidate actions comprises at least one of:
locating content related to the webpage;
generating a summary of the webpage;
identifying one or more key points of the webpage; or
answering a user question about the content of the webpage.

11. The electronic device of claim 9, wherein:
the information associated with the webpage comprises webpage metadata associated with the webpage;
the at least one processing device is further configured to obtain a browsing history associated with the user and profile information associated with the user;
the prompt is based on the browsing history, the profile information, and the webpage metadata.

12. The electronic device of claim 9, wherein the at least one processing device is further configured to:
identify how the user interacts with the presented response; and
update one or more weights of the on-device machine learning model based on how the user interacts with the presented response.

13. The electronic device of claim 12, wherein, to identify how the user interacts with the presented response, the at least one processing device is configured to at least one of:
determine whether the user copies content included in the response;
determine a time that the user spends viewing the response; or
determine how the user rates the response.

14. The electronic device of claim 9, wherein, to generate the prompt, the at least one processing device is configured to:
determine a likelihood that the large language model was trained using outdated training data; and
one of:
in response to the likelihood exceeding a threshold, extract text from the webpage and include the text in the prompt; or
in response to the likelihood not exceeding the threshold, include a uniform resource locator (URL) associated with the webpage in the prompt.

15. The electronic device of claim 9, wherein the at least one processing device is further configured to:
determine whether the webpage includes sensitive information; and
in response to determining that the webpage includes sensitive information, at least one of: not provide the sensitive information to the on-device machine learning model or not include the sensitive information in the prompt.

16. The electronic device of claim 9, wherein:
the prompt comprises a first prompt;
the response comprises a first response; and
the at least one processing device is further configured to:
generate a second prompt for the large language model based on the information, the second prompt phrased differently than the first prompt;
provide the second prompt as input to the large language model;
receive a second response from the large language model;
compare the first and second responses; and
select one of the first and second responses for presentation to the user.

17. A non-transitory machine readable medium containing instructions that when executed cause at least one processor of an electronic device to:
obtain information associated with a webpage presented to a user;
provide the information to an on-device machine learning model of the electronic device;
generate, using the on-device machine learning model, a prompt for a large language model based on the information, the prompt including (i) an action from a set of candidate actions that the large language model is able to perform and (ii) at least some of the information;
provide the prompt as input to the large language model;
receive a response from the large language model; and
present the response to the user.

18. The non-transitory machine readable medium of claim 17, further containing instructions that when executed cause the at least one processor to:
identify how the user interacts with the presented response; and
update one or more weights of the on-device machine learning model based on how the user interacts with the presented response.

19. The non-transitory machine readable medium of claim 17, wherein the instructions that when executed cause the at least one processor to generate the prompt comprise:
instructions that when executed cause the at least one processor to:
determine a likelihood that the large language model was trained using outdated training data; and
one of:
in response to the likelihood exceeding a threshold, extract text from the webpage and include the text in the prompt; or
in response to the likelihood not exceeding the threshold, include a uniform resource locator (URL) associated with the webpage in the prompt.

20. The non-transitory machine readable medium of claim 17, further containing instructions that when executed cause the at least one processor to:
determine whether the webpage includes sensitive information; and
in response to determining that the webpage includes sensitive information, at least one of: not provide the sensitive information to the on-device machine learning model or not include the sensitive information in the prompt.
